(19) United States
(12) Patent Application Publication
(10) Pub. No.: US 2007/0045884 A1
(43) Pub. Date: Mar. 1, 2007

(54) Procedure for the production of a fireproof ceramic product, use of the product and procedure for the change of a melt with the product

(75) Inventors: Franz Reiterer, Leoben (AT); Boro Djuricic, Leoben (AT)

Correspondence Address: WALKER & JOCKE, L.P.A., 231 SOUTH BROADWAY STREET, MEDINA, OH, 44256, US

(73) Assignee: Refractory Intellectual Property GmbH & Co. KG, Wien (AT)

(21) Appl. No.: 11/217,069

(22) Filed: Aug. 30, 2005

(51) Int. Cl. F27D 1/16

(52) U.S. Cl. 264/30

(57) ABSTRACT

Products, especially masses and shaped parts with fire-resistant (refractory) qualities when used in an authorized application, are used in particular in devices for receiving, treating and/or transporting melts. Such melts can be steel melts (ferrous melts), non-ferrous melts (such as copper melts) as well as glass melts or rock melts, whereby such melts customarily have temperatures between 1000° C. and 2000° C. According to the invention these refractory products are used to amend the corresponding melt.

Products, especially masses and shaped parts with fire-resistant (refractory) qualities when used in an authorized application, are used in particular in devices for receiving, treating and/or transporting melts. Such melts can be steel melts (ferrous melts), non-ferrous melts (such as copper melts) as well as glass melts or rock melts, whereby such melts customarily have temperatures between 1000° C. and 2000° C.

The term “fire-resistant” signifies in this context that the products have a technically sufficient life in relation to the melt over a technically relevant time period.

Accordingly, the requirements on the fire-resistant material with which the corresponding devices (units) such as melting ladles or melting tubs are jacketed concentrate on a high temperature resistance, long service life and various mechanical qualities, e.g., the modulus of elasticity. This applies in an analogous manner for fire-resistant material that is used as so-called functional products. Functional products are refractory ceramic products that meet other tasks in addition to the cited qualities: This includes: Products for transporting and conducting a melt (such as tubes, conduits), products for regulating/controlling a melt flow (such as sliding plates, stoppers, tundish dams), products that offer impact protection (such as impact pads, impact pots) or products for conducting treatment media (such as gas purging devices).

A good corrosion behavior, good resistance to temperature changes or good oxidation protection frequently play a substantial role for such products.

The corrosion resistance of fire-resistant products to process slags (especially metallurgical slags) can be improved by the addition of carbon (C) in combination with refractory oxides (such as MgO or Al₂O₃). The tendency of the carbon to oxidize can be reduced by the addition of oxidation-inhibiting additives (so-called antioxidants) into the fire-resistant material.

As presented in connection with the corrosion behavior, the development of novel fire-resistant materials concentrates in particular on the improvement of the service life of the products.

This applies to monolithic masses as well as to shaped parts and not only to those products used for the lining of walls, bottoms and ceilings (covers) but also to the cited functional products.

The invention differs from these profiles that have been at a standstill for decades. The main concept of the invention is to design refractory products of the cited type in such a manner that the products can be actively used in the particular process. The refractory material is made a component of process engineering. The quality and properties of the melt as well as the quality of properties of the product produced from the melt can be adjusted and/or optimized with the aid of the refractory material. The melting/treatment vessel (hereinafter called device) becomes a type of reactor for adjusting the melt and the products produced from it by the active role of the material of the refractory product.

As described in detail in the following, the refactory product can be used in accordance with the invention after a corresponding adaptation, e.g., as a dispenser for introducing alloying metals into a metal melt or as reaction partner in a glass melt in order to change the particular melt in its composition and/or its properties in a purposeful manner (in a desired manner).

The fire-resistant (refractory) material should retain its previous functions, e.g., as a lining material in appropriate melting vessels; however, the fire-resistant material additionally receives completely new tasks.

For this, the fire-resistant material is adapted already during its production taking into consideration the engineering parameters of the later application. This will be shown by an example:

A steel melt is to be metallurgically treated in a ladle that is to be equipped (jacketed) with fire-resistant products. The “actual analysis” of the steel melt in the device deviates from the “theoretical analysis”. For example, the contents of the alloying components Co (cobalt), Mn (manganese) and/or Ce (cerium) are too low in the melt.

According to the state of the art the supplying of these lacking alloying metals takes place, e.g., via so-called alloying wires like those described in DE 29 48 636 A1. The production of these alloying wires is expensive. The introduction of the wires into the melt constitutes an additional process step. The lacking alloying components can only be introduced into the melt with the aid of a wire at a few concrete locations. The subsequent necessary distribution in the melt (in the melt bath) is correspondingly expensive.

Another known method consists in throwing the lacking alloying components as powder onto the melting bath. The problem arises in this case that a large part remains caught in the slag covering the melt. A homogeneous dosing and distribution in the melt is not possible.

The invention makes no separate intervention in the running treatment process. According to the invention lacking components of the melt can be made available from the fire-resistant material (that is necessary and present in any case) directly or by reaction of the melt with the fire-resistant material. However, certain components of the originally present melt can also be removed from the melt by a reaction of the fire-resistant material with the melt. In both cases the originally present melt is amended. In particular, the following amendments are referred to, that are all subsumed under the term “analysis”:
Chemical composition of the melt
Chemical bonding state of the melt components (e.g.: metal, oxide, carbide, nitride)
Distribution of alloying components and/or non-metallic solids in the metal melt
Morphology (e.g.: size and shape) of non-metallic inclusions in the metal melt.

Changes of the melt by the fire-resistant material or reactions of the melt with the fire-resistant material can take place according to the invention, e.g., by purposefully changing at least one of the following parameters:
Temperature of the melt
Melt volume
Time of melt treatment
Composition of the fire-resistant material of the product
Structural composition of the fire-resistant product
Density of the fire-resistant product
Contact area between fire-resistant product and melt.

Thereby specific adaptation of the fire-resistant material of the product to the particular application takes place. The “application” may concern an individual specific melt in a certain device. However, the application may also concern typical general conditions and properties of certain melts in corresponding devices. Accordingly, the product can be adapted in such a manner that deviations in the components and amounts of the components of the melt are considered entirely or in part.

To this extent the invention relates in its most general embodiment to a process for producing a ceramic product that is fire-resistant when used in an authorized manner as a lining material or a functional product of a device for receiving, treating and/or transmitting (transporting) a melt, with the following steps:
Preparation of a ceramic batch comprising several batch components,
Selection and adjustment of at least one batch component in such a way that after a processing of the batch to the ceramic product and after contacting a melt with the product in a manner in conformity with the application, deviations between an actual analysis of a melt taken from the device and a theoretical analysis are less relative to at least one melt component than compared with the melt supplied to the device or previously treated in the device.

The invention begins with the production of the fire-resistant product, namely, while taking into account the properties and composition of the melt with which the product comes in contact during the application. For example, the following production steps can be carried out in this connection:
A batch component is added in a purposeful manner into the batch which component forms a component in the fire-resistant product which component is released during use (in contact with the melt) from the product into the melt in order to increase the portion of this component in the melt,
A batch component is added in a purposeful manner into the batch which component forms a component in the fire-resistant product which component becomes a reaction partner of the melt during use (in contact with the melt) and correspondingly changes the composition and/or the properties of the melt.

The fire-resistant material can be consumed proportionately. The wear of the product is adjusted e.g., specifically to the application in such a manner that the desired amount of the desired component(s) passes into the melt during a melt batch from the eroded and/or corroded fire-resistant material. However, it is also possible that new reaction products form between the fire-resistant material of the product and the melt by the described reaction mechanisms which new reaction products accumulate on the fire-resistant product, e.g., forming a layer. In this case even the passive properties of the fire-resistant product (such as the wear protection and temperature protection) may be changed and, in particular, be improved. Such layers (deposits) may also be striven for locally in a purposeful manner, e.g., in the contact area between the slag and the refractory product of metallurgical devices.

The manufacturer of the product may obtain concrete information about the theoretical and actual analyses of at least one melt coming into contact with the product. This information may also derive from the plant in which the products are used. It can also be made available or estimated by an external laboratory. The manufacturer of the product may accordingly adjust the recipe for the product batch-specifically or in such a manner that certain basic components required for several applications are made available in a certain amount and/or preparation. For example, a certain alloying metal can be added to the batch in a certain amount that is normally lacking in melts of a certain type or that is contained in concentrations that are too low. This can be, e.g., certain noble metals or rare-earth metals.

The program for the production of the product reads: Addition of at least one substance to the batch in a certain form and amount in such a manner that the melt with which the product makes contact in accordance with the application receives the desired change.

The change in the composition of the melt can not only be achieved via the wear of the fire-resistant material but also via the dispensing of substances with the aid of the product. For example, the following changes can take place in the production of the product:

The product is produced with a specific porosity, in particular an open porosity whereby certain substances are deposited in the pore spaces of the product, e.g., via an impregnation treatment of the product.

The temperature of the melt can be varied during use (e.g., the temperature is briefly raised) in order to melt these substances that are components of the fire-resistant product and to dispense them into the melt. Likewise, certain desired reactions between melt and fire-resistant material can be initiated at an elevated melt temperature in order to change the melt in this manner.

The batch for producing the fire-resistant product can be adapted in such a manner that the ready product enters during use at least partially into a chemical reaction with the melt. In this manner certain undesired components can be removed from the melt, e.g., non-metallic inclusions can be transferred into the slag layer.

The last-cited variants make it possible to create reaction products that are subsequently taken up directly as alloying components by the melt.

An important advantage of the inventive concept is that a large fire-resistant surface is frequently in contact with an associated melt so that, e.g., alloying components can be transferred uniformly even in very slight amounts (concentrations) into the melt and homogenized. The invention is therefore used in particular in conjunction with components whose mass fraction in the melt being <5%, frequently <1 or <0.1%. The correction amount (raising/lowering) is usually distinctly less than 1 percent by mass, frequently less than 0.5 or less than 0.1 percent by weight and frequently <500 or <100 ppm. Thus, the invention makes efficient possibilities available for amending an alloy with very slight amounts of additives (also called micro-alloying).

The supplying of certain substances (or compounds) from the fire-resistant material into the melt can be carried out in a purely physical manner in that fire-resistant shaped parts are formed, e.g., with an appropriate depot. This can be a hollow space in the product that communicates with the melt via at least one capillary or a conduit. The desired substances can be received in this depot. The substances present in the depot are dispensed by adjusting appropriate pressure conditions. The pressure can be adjusted, e.g., via the thermal expansion of the fire-resistant material at certain temperatures or via a purposeful formation of gas in the product.

Products of the cited type should often have a long life. If the products are used in accordance with the invention as dispensers or catalyst in the supplying of certain, in particular slight amounts of substances into the melt, a purposeful degree of wear results in certain applications. The follow examples show that this is possible.

In as far as higher dosages are necessary, the substances may be integrated into fire-resistant products that experience rapid wear, e.g., monolithic masses that are reapplied batchwise. In other words: Prior to the filling of a device with melt a monolithic refractory coating comprising the desired substances (components) is applied onto the lining. This layer is entirely or partially consumed after the device has been filled with the melt. The mass of the fire-resistant coating, the amount of dosing agent as well as the following degree of wear may be calculated in advance as a function of the amount of treated melt and appropriately adapted.

A similar situation can be achieved when using impact pads or impact containers. These functional products protect the fire-resistant lining against a striking casting jet and guide the melt. According to the invention these impact elements can be doped with certain substances and produced with a defined, application-specific degree of wear. The impact bodies then wear down in a certain time and dispense the desired substances into the melt parallel to the wear, where they are uniformly distributed by the flow of the metal stream. In this application too the new function of the fire-resistant material as dispenser for the supplying of certain components into a melt becomes clear. This applies in an analogous manner to the use in sliding plates, spouts, ceramic filters, etc.

In sliding plates the area immediately around the flowthrough opening (for the melt) wears down especially fast. In the state of the art this area was designed to be replaceable and/or very strong. According to the invention especially the material of this part of the sliding plate is changed in such a manner that the melt is changed in the desired manner after making contact with the product. Appropriate inserts, e.g., in the form of rings or cylinders can also be integrated into the flowthrough areas of immersion tubes, spouts, casting nozzles or other parts that serve to control/regulate a melt flow. Several inserts can be provided on one product. In this manner, different corrections of the melt can take place at the same time. Analogously, fire-resistant ceramic bodies of any geometry can be added at a position of a device of the cited type that comes in contact with the melt in order to serve in this manner as dispensers for certain substances or as reaction partners for the melt for the latter.

As a result of the specific amendment (adaptation) of the fire-resistant material of the products, melts can be amended not only as concerns certain components but even the physical properties of a melt can be adjusted. An example of this follows:

Steel melts can contain undesired portions of Al₂O₃. The aluminum oxide is produced during the deoxidation of the steel melt by metallic aluminum. Al₂O₃ can be tolerated in the melt only in a certain amount and particle size. Excess Al₂O₃ is therefore transferred via known secondary metallurgical processes into a slag. According to the invention the removal of Al₂O₃ can be supported in various ways:
A reaction partner, e.g., CaO, for the aluminum oxide to be separated is integrated into the fire-resistant product. Calcium aluminates, that can be readily separated out, form by the reaction of the CaO from the fire-resistant material with Al₂O₃ from the melt.
Fine particles of Al₂O₃ are integrated into the fire-resistant product. They form crystallization nuclei for the aluminum oxide to be separated out upon contact with the steel melt. The coarser Al₂O₃ particles thus formed can be more easily transferred into the slag.

The unintended separation of melt components on the product (so-called clogging) can be avoided in an analogous manner.

A few examples are intended to illustrate, without excluding other components from the application of the invention, which components for which purposes of application can be integrated in accordance with the invention into the fire-resistant material:

In products for use in contact with a steel melt or non-ferrous melts:
Metals such as Al, Ti, Zr, Ni, Mn, Sc, Ce, Nb, V or alloys of metals and other elements
Oxides, borides, nitrides, carbides.

According to the invention alloying components can be brought into the metallic melt via the fire-resistant material. Thus, metals such as Nb, Ti or V can positively influence the steel strength and the creeping behavior of the steel. Nb also serves to improve the properties of alloys used in a corrosive environment.

In products for use in contact with glass melts:
Oxides, especially metal oxides such as SiO₂, Al₂O₃, B₂O₃, Nb₂O₅, Na₂O, MgO, PbO, CeO₂, La₂O₃.

The invention makes it possible to influence the glass quality by a purposeful shaping of the fire-resistant material. In this respect, the glass melt is amended.

Nb₂O₅ can improve the quality of optical glasses. CeO₂ serves to increase the transparency of glass. La₂O₃ additives improve the temperature properties of glass.

The invention also comprises the use of a ceramic product that is fire-resistant in an intended (authorized) use as lining material or functional product of a device for receiving, treating and/or conducting a melt. The use resides in the fact that the product is employed for the purposeful amendment of the melt by
a dosed, application-specific dispensing of at least one substance from the product into the melt, and/or
an application-specific reaction of at least one substance from the product with at least one melt component.

The invention also relates to a process for the purposeful amendment of a melt handled in a device comprising a ceramic product in the contact area with the melt, which product is fire-resistant when used in the authorized manner, whereby this product comprises at least one substance that changes the melt by at least one of the following reaction mechanisms:
The substance is dispensed when used as authorized from the fire-resistant material of the product into the melt in a dosed manner.
The substance reacts with at least one melt component.

The composition of the product is always adjusted in accordance with the desired amendment of the melt during production.

A new product is produced that differs in its composition and/or its physical/mechanical properties from a product known in the state of the art that is/was used for the same applications.

The new product no longer has only a passive protective function but rather enters into a regulated/controlled chemical/metallurgical interaction with the associated melt. Reference is made to the previous explanations.

The desired amount of the component(s) received by the melt and/or dispensed by the melt, is usually calculated on a basis of time unit and/or per unit of mass and/or per unit of volume.

In discontinuous melting processes this figure may be related to the amount of melt per batch.

In continuous melting processes the amounts of components can refer, among other things, to the flowthrough amount of the melt per time unit.

The invention relates to products that have fire-resistant properties during their production already as well as to products that become fire-resistant only upon their authorized use. For example, the invention comprises products of the following cited types:
MgO—C bricks
Masses and shaped parts based on alumina
Zirconium oxide products
Silica bricks,
   each with additives of the cited type.

A few possible exemplary applications are presented in the following.

### EXAMPLE A

A glass melt is to be treated in a glass melting vessel lined with fire-resistant bricks. Such a vessel is customarily operated continuously, that is, in continuously running operation. However, for the sake of simplicity a discontinuous operation is taken as the starting point for the following calculations.

The vessel is rectangular in a top view (5×6.67 m effective inner length/width between the fire-resistant walls). The fillable height is 1.0 m. This yields an effective vessel volume of 33.33 m³. The vessel can receive 100,000 kg melt at an assumed specific weight of the melt of 3000 kg/m³.

The melt makes contact with the fire-resistant wall surfaces and bottom surfaces (=product) of the vessel, that are calculated in their entirety at 56.66 m². The fire-resistant lining is made of calcined zirconium silicate bricks.

It is assumed that an amount of 5 ppm of a substance (here:CeO₂) is to be supplied to the glass melt via the wear of the fire-resistant product. This corresponds, relative to 100,000 kg melt, to an added amount of 0.5 kg CeO₂. This is taken into consideration during the production of the product in such a manner that the finished product comprises 1.0 wt % CeO₂ in homogeneous distribution. It follows from the above at a specific weight of the fire-resistant material of 4000 kg/m³ that 0.0125 m³ fire-resistant material must be dissolved and transferred into the melt in order to transfer the desired amount of CeO₂ into the melt.

This means, relative to the entire contact surface of fire-resistant material/glass melt of 56.67 m², that the fire-resistant material must be removed at a thickness of 0.00022 m (=0.22 mm) in order to bring 5 ppm CeO₂ into 100,000 kg melt. It furthermore follows from the above that after around 450 batches (total melt amount 45,000,000 kg) a total wear of the fire-resistant lining of approximately 0.1 m (=100 mm) would result.

If the additive (CeO₂) is dosed in the product ten times higher, the desired wear of the product is reduced by a power of 10 to 0.02 mm for each 100,000 kg melt. Accordingly, an assumed, tolerable total wear of around 100 mm (0.1 m) would be achieved only after approximately 4500 batches (450,000,000 kg melt).

It is understood that even several additives (doping substances) can be worked into (integrated into) the fire-resistant material of the product at the same time. Given the same portions, the required wear of the fire-resistant material also remains unchanged.

An alternative embodiment provides products based on aluminum oxide (Al₂O₃) with the addition of fine (<100 μm) lanthanum oxide.

### EXAMPLE B

This embodiment relates to the lining of a rotary kiln for burning cement clinker. The rotary kiln should have an effective length (along which the fire-resistant material of the lining makes contact with the cement clinker) of 10 m and an effective inner radius of the refractory lining wall of 3 m. This yields a total surface of the product that comes in contact with the clinker of 188.5 m².

According to the invention the term “melt” also includes solid-liquid systems like those that occur during clinker firing. A certain amount of melt is always present in the kiln besides the solid clinker portions.

A clinker throughput of 50,000 kg/h is assumed. A throughput volume of 25 m³ cement clinker per hour results at a specific weight of the cement clinker of 2,000 kg/m³.

5 ppm tin (II) sulfate are to be added to the cement clinker. This component serves as an auxiliary grinding aid for the calcined cement clinker (EP 0976695 B1). This corresponds, relative to the cement clinker, to an amount of 0.25 kg/h. Accordingly, at an added amount of 1 wt % tin (II) sulfate in the fire-resistant material (calcined magnesia-chromite brick, impregnated with a tin (II) sulfate lotion) of the kiln lining, 25 kg fire-resistant material must be “consumed” per hour in order to be able to transfer the desired amount of tin (II) sulfate into the clinker.

A volume of 0.00833 m³ refractory material to be consumed per hour is calculated from the above at an assumed specific weight of the fire-resistant material of 3,000 kg/m³.

This corresponds at a total surface of the fire-resistant material of around 188.5 m² to a required wear of the fire-resistant material of 0.00004 m/h (=0.04 mm/h).

The required wear rate decreases to 0.004 mm per hour at an added amount of 10 wt % tin (II) sulfate in the fire-resistant material. In this embodiment too a homogeneous distribution of the additive in the batch is assumed for producing the fire-resistant lining.

It is to be noted in general that this is not absolutely necessary in particular in the case of rare and/or expensive substances. If it is assumed that a refractory lining must always have a certain residual thickness for reasons of safety, it becomes clear that in particular this part of the refractory lining, facing away from the melt, does not have to be mixed with the additional substances. This can be readily achieved during the production of bricks in that different batches are filled into the press mould during the pressing of the bricks.

Further, as has already been mentioned, the layers doped in accordance with the invention may also be applied as monolithic masses, e.g., onto a permanent lining constructed in a conventional manner.

### EXAMPLE C

This example shows the last-cited area of application of monolithic masses. The starting point is a ladle that should ideally here have a cylindrical shape. The ladle has a lining made of fire-resistant bricks based on alumina (Al₂O₃), that is designated in the following as a permanent lining. With this permanent lining the inside radius of the ladle is 1.23 m and the height 3 m. An inner surface of the permanent lining of 23.2 m² is calculated from the above. With the addition of the bottom surface of 4.76 m² a total surface of the fire-resistant material of around 27.96 m² results.

The effective ladle volume (14.29 m³) permits the receiving of 100,000 kg melt at a specific weight of the metallic melt of 7,000 kg/m³.

The metallic melt should additionally be doped with 250 ppm each of the alloying metals lanthanum (La) and titanium (Ti).

In this case the invention provides the use of a monolithic gunning mass that is applied onto the permanent lining. The batch of the gunning mass contains, in addition to an alumina matrix and binder, 15 wt % of the alloying metal lanthanum and 15 wt % of the alloying metal titanium. Both metals are homogeneously mixed as a fine powder (<100 μm) into the batch components during the preparation. In order to be able to transfer 50 kg (2×25 kg) of the alloying metals into the melt, 166.67 kg fire-resistant material must be correspondingly consumed. At a specific weight of the gunning mixnd of 3,000 kg/m³ a volume for the refractory material to be consumed (calculated on 100,000 kg melt) of 0.055 m³ is calculated.

This corresponds at the cited total contact surface of 27.96 m² (that is also assumed here for the contact surface of the gunning mass applied onto the permanent lining) to a consumption (removal) of the fire-resistant material of 0.00199 m (=1.99 mm).

A required degree of wear of the gunning compound of 1.19 mm per 100,000 kg melt is calculated at a required alloying amount of 100 ppm of each alloying metal and an added amount of 10 wt % in the fire-resistant material of the gunning compound.

### EXAMPLE D

The starting point is the steel ladle of example C. Even the amount of melt should remain unchanged relative to example C.

However, in distinction to example C it is assumed in this embodiment that the melt is to be doped with an amount of 5 ppm niobium (Nb). Therefore, 0.5 kg niobium are required per 100,000 kg melt.

The use of a gunning mass with a high degree of wear can be avoided here because of the low amount of the niobium component to be transferred out of the product (lining material) into the metallic melt. The required amount of niobium can be transferred into the melt via a minimum amount of wear of the fire-resistant wall. To this end the batch for producing the bricks is adjusted in such a manner that the finished product (based on MgO—C) comprises 1 wt % niobium as fine particles (<100 μm) as a ferroalloy. Then, per 100,000 kg melt, 50 kg fire-resistant material (based on alumina) must be consumed (or 0.0167 m³ at a specific weight of the fire-resistant material of 3000 kg/m³).

A consumption of 0.6 mm fire-resistant material per 100,000 kg melt results relative to the total contact surface fire-resistant material/steel melt. Converted to 100 batches, this corresponds to a total wear of the fire-resistant material of around 60 mm (=0.06 m).

This total wear can be reduced with each 100 batches by a power of 10 (to 0.006 m) if the amount of niobium in the fire-resistant material is increased from 1 to 10 wt %.

The fire-resistant material can also be a silicon carbide material stabilized with silicon nitride.

This example can be substantially transferred in an analogous manner to the melting/treating of a nonferrous melt, e.g., a melt consisting of an aluminum alloy. In this instance niobium is replaced by scandium.

### EXAMPLE E

100,000 kg steel are to flow through a cylindrical ZrO₂ insert of a pouring nozzle of zirconium oxide (ZrO₂) within the scope of a process for treating a steel melt. The cylinder has a height of 0.2 m and an inside radius of 0.03 m, therefore an inside jacket surface of 0.0377 m².

According to the invention this process step is used to alloy the metallic melt with 1 ppm Ti (titanium). 0.1 kg titanium is then required for 100,000 kg melt. The batch for producing the cylindrical body is prepared with 30 wt % titanium.

The steel melt can be alloyed with 1 ppm titanium if 0.33 kg fire-resistant material (=0.00011 m³ fire-resistant material at a specific weight of the fire-resistant material of 3,000 kg/m³) is dissolved.

This corresponds, relative to the jacket surface of 0.0377 m² to a consumption of the fire-resistant material of 0.00295 m (=2.95 mm).

This corresponds to approximately 3 batches of the cited magnitude at a technically justifiable wear of the fire-resistant material of 0.01 m (=10 mm).

An embodiment provides a porous ZrO2 ceramic material in which the titanium is infiltrated as ferrotitanium.

The following applies in general:

For reasons of simplicity the referenced contact surface (lining surface) of the fire-resistant material was not changed in the previous calculations. It is obvious that this surface becomes correspondingly larger with each wear. The required wear of the fire-resistant material, calculated as volume, has the consequence that the wear depth of the fire-resistant material becomes constantly smaller. This increases the possible service life of the fire-resistant material in a corresponding manner.

This effect can be taken into consideration industrially in various ways in the production of the fire-resistant product:
For example, the degree of wear of the fire-resistant material can be differently adjusted, e.g., in that the porosity of the contact surface with the melt decreases in the direction of the opposite outside surface and/or the strength increases.
It is also possible to increase the concentration gradient of the cited components vertically to the contact surface with the melt so that in accordance with a lesser wear depth the same amount of the desired component is nevertheless transferred into the melt.

The features of the invention mentioned in the description and the claims can be used individually as well as in combinations for the realization of the invention. Individual components, ranges, process steps, material groups or product groups or areas of application may be excluded, if appropriate.

1. A process for the purposeful amendment of a melt in a device that comprises a ceramic product in a contact area with the melt which product is fire-resistant when used as authorized, whereby the product comprises at least one substance that amends the melt by at least one of the following measures:
a) The substance is dispensed in a dosed manner into the melt during an authorized usage,
b) The substance reacts with at least one melt component and amends the amount of this melt component in the melt.

2. A process for producing a ceramic product that is fire-resistant when used as authorized as a lining material or functional product of a device for receiving, treating and/or transporting a melt, with the following steps:
a) Preparation of a ceramic batch made of several batch components,
b) Selection and adjustment of at least one batch component in such a manner that after a processing of the batch to the ceramic product and after contact of the melt with the product in a manner in conformity with the application deviations between an actual analysis of the melt and a theoretical analysis of a melt removed from the device are less regarding at least one melt component than in the melt supplied to the device or previously treated in the device.

3. The use of a ceramic product that is fire-resistant when used as authorized as a lining material or functional product of a device for receiving, treating and/or transporting a melt for the purposeful changing of the melt by
a) a dosed, application-specific dispensing of at least one substance from the product into the melt,
b) an application-specific reaction of at least one substance from the product with at least one melt component.
